(19) United States
(12) Patent Application Publication
(10) Pub. No.: US 2016/0350837 A1
(43) Pub. Date: Dec. 1, 2016

(54) INTELLIGENT DELIVERY QUEUING

(71) Applicant: Accenture Global Services Limited, Dublin (IE)

(72) Inventors: Thomas Williams, Dublin (IE); Leona Seaward, Oxfordshire (GB); John Thirlaway, Dublin (IE); Jonathan Haynes, Dublin (IE)

(21) Appl. No.: 14/828,818

(22) Filed: Aug. 18, 2015

Related U.S. Application Data
(60) Provisional application No. 62/169,474, filed on Jun. 1, 2015.

(51) Int. Cl. G06Q 30/06; G06Q 50/12

(52) U.S. Cl. CPC G06Q 30/0633; G06Q 50/12

(57) ABSTRACT

In one implementation, a computer-implemented method includes receiving, from a mobile computing device, a food order that specifies one or more items to be fulfilled by a particular provider; determining a current location of the mobile computing device; identifying a location of the particular provider; determining an estimated time of arrival for the user; identifying one or more fulfillment time periods for the food order; determining, based, at least in part, on (i) the estimated time of arrival and (ii) the one or more fulfillment time periods, one or more future times at which the particular provider is to begin preparing the one or more items; generating food order instructions for the particular provider based, at least in part, on (i) the food order and (ii) the one or more future times; and providing the food order instructions to a provider computer system.

### CROSS-REFERENCE TO RELATED APPLICATION

This application claims the benefit of U.S. Provisional Application No. 62/169,474, filed Jun. 1, 2015, and titled “ Intelligent Delivery Queuing,” which is incorporated by reference.

### TECHNICAL FIELD

This document generally describes technology related to computer-generated queueing of electronic orders, such as orders for food items placed through mobile applications.

### BACKGROUND

Mobile computing devices (e.g., smartphones, tablet computing devices, wearable computing devices) have been programmed to assist users with placing orders for goods and services. For example, users can download and install mobile applications (“mobile apps”) for retailers, and can use the mobile apps to browse goods, select goods (e.g., place goods in an electronic shopping cart), purchase the selected goods (e.g., electronically checkout), designate a way for the user to get the goods (e.g., delivery, in-store pickup), and can track the progress of their orders (e.g., view order status).

Some mobile apps can use location information for mobile computing devices to provide information that is relevant to users of the mobile devices. For example, a navigational mobile app that is running on a mobile computing device can provide directions to a user of a mobile computing device based on an identified destination location and the current location of the mobile computing device.

### SUMMARY

This document generally describes generating intelligent order queueing information to be used by providers, such as restaurants that are processing food orders. Such intelligent order queueing information can include information that takes into account estimated times of arrival for customers, such as customers who will be picking-up the food at a provider's location, as well as the time for fulfilling items included in food orders. For example, a computer system can determine an estimated time of arrival for a customer to arrive at a pizza restaurant (example provider) to pick up a pizza (example food order) as well as the time it takes the pizza restaurant to make the pizza (fulfillment time), and can use that information to provide the pizza restaurant with information, such as timing information, that it can use to determine when to begin preparing the pizza so that it is ready when the customer arrives at the restaurant.

In one implementation, a computer-implemented method includes receiving, at a computer system and from a mobile computing device, a food order that specifies one or more items to be (i) fulfilled by a particular provider and (ii) picked-up by a user of the mobile computing device; determining, by the computer system, a current location of the mobile computing device; identifying, by the computer system, a location of the particular provider; determining, by the computer system, an estimated time of arrival for the user to travel from the current location of the mobile computing device to the location of the particular provider; identifying, by the computer system, one or more fulfillment time periods for the food order, the one or more fulfillment time periods corresponding to one or more lengths of time for the one or more items to be fulfilled as part of the food order; determining, by the computer system and based, at least in part, on (i) the estimated time of arrival and (ii) the one or more fulfillment time periods, one or more future times at which the particular provider is to begin preparing the one or more items so that the food order will be fulfilled and available for pick-up within a threshold period of time of the user arriving at the particular provider's location; generating, by the computer system, food order instructions for the particular provider to prepare the food order based, at least in part, on (i) the food order and (ii) the one or more future times; and providing, by the computer system, the food order instructions to a provider computer system associated with the particular provider.

Such a computer-implemented method can optionally include one or more of the following features. The computer-implemented method can further include selecting, by the computer system, an estimated route that the user will use to travel from the current location of mobile computing device to the location of the particular provider. The estimated time of arrival can be determined based, at least in part, on the estimated route. The computer-implemented method can further include identifying, by the computer system, one or more transit delays along the estimated route. The estimated time of arrival can be determined further based on the one or more transit delays. The computer-implemented method can further include identifying, by the computer system, historical travel times for travelling along some or all of the estimated route. The estimated time of arrival can be determined further based on the historical travel times. The historical travel times can include historical travel times for the user travelling along some or all of the estimated route. The computer-implemented method can further include identifying, by the computer system, a plurality of candidate routes for the user to travel from the current location of the mobile computing device to the location of the particular provider. The estimated route can be selected from among the plurality of candidate routes based on historical travel patterns of the user.

The computer-implemented method can further include receiving, at the computer system, an updated location of the mobile computing device; determining, by the computer system, an updated time of arrival for the user at the location of the particular provider based, at least in part, on the updated location; and providing, by the computer system, updated information that identifies the updated time of arrival for the user to the provider computer system associated with the particular provider. The computer-implemented method can further include determining, by the computer system, whether the updated time of arrival for user to arrive at the particular provider's location has deviated from the estimated time of arrival by more than a threshold amount of time. The updated information can be provided to the provider computer system in response to determining that the updated time of arrival has deviated from the estimated time of arrival by more than the threshold amount of time. The computer-implemented method can further include determining, by the computer system, whether to suggest another provider fulfill the food order based, at least in part, on the updated location of the mobile computing device and the updated time of arrival at the location of the particular provider; and selecting, by the computer system in response to determining to suggest another provider, an alternate provider for the food order based, at least in part, on (i) a location of the alternate provider, (ii) the updated location of the mobile computing device, and (iii) fulfillment services provided by the alternate provider or an affiliation between the alternate provider and the particular provider. The updated information can include information that identifies the alternate provider and provides an option to change fulfillment of the food order from the particular provider to the alternate provider.

The computer-implemented method can further include receiving, at the computer system and from the mobile computing device, a request to change fulfillment of the food order to the alternate provider; providing, by the computer system and to the provider computer system associated with the particular provider, instructions to cancel fulfillment of the food order by the particular provider; and providing, by the computer system and to another provider computer system associated with the alternate provider, information for the food order. The computer-implemented method can further include determining, by the computer system and based on the updated time of arrival, one or more updated future times at which the particular provider is to begin preparing the one or more items so that the food order will be fulfilled and available for pick-up within a threshold period of time of the updated time of arrival; and generating updated food order instructions for the particular provider to prepare the food order based, at least in part, on (i) the food order and (ii) the one or more updated future times. The updated food order can be included in the updated information that is provided to the provider computer system.

The computer-implemented method can further include determining, by the computer system, whether fulfillment of the food order has already begun based, at least in part, on (i) a current time when the updated location of the mobile computing device is received and (ii) the one or more future times at which the particular provider is to begin preparing the food order; and providing, by the computer system and in response to determining that fulfillment of the food order has already begun, a notification to the mobile computing device that indicates the food order has already begun being fulfilled and an estimated time when the food order will be available. The computer-implemented method can further include determining, by the computer system, whether fulfillment of the food order has already begun based, at least in part, on (i) a current time when the updated location of the mobile computing device is received and (ii) the one or more future times at which the particular provider is to begin preparing the food order; and providing, by the computer system and in response to determining that fulfillment of the food order has not yet begun, instructions to the mobile computing device output one or more selectable features for the user to modify or cancel the food order. The computer-implemented method can further include receiving, at the computer system and from the mobile computing device, one or more modifications to the food order; determining, by the computer system, one or more modified future times for the particular provider to being fulfilling the food order based, at least in part, on the one or more modifications to the food order and the future times; and providing, by the computer system and to the provider computer system, information that identifies one or more modification to the food order and the one or more modified future times.

The computer-implemented method can further include accessing, by the computer system, current orders that are pending for fulfillment with the particular provider. The one or more future times can be determined further based on the current orders.

In another implementation, a computer-implemented method includes outputting, by the mobile computing device, a user interface for placing orders with one or more providers; receiving, through the user interface, input that specifies a food order to be placed with a particular provider, wherein the food order includes one or more items and specifies that a user associated with the mobile computing device will pick-up the food order at the particular provider's location; providing, by the mobile computing device and to a computer system, order information that describes the food order and location information that identifies a current location of the mobile computing device, wherein the computer system is programmed to (i) determine an estimated time when the food order will be available for pick-up based, at least in part, on an estimated time of arrival for the user to travel to the particular provider's location, and (ii) provide the food order to a provider computer system that is associated with the particular provider; receiving, at the mobile computing device and from the computer system, information that identifies, at least, the estimated time when the food order will be available for pick-up; and outputting, by the mobile computing device and through the user interface, the estimated time when the food order will be available for pick-up.

Such a computer-implemented method can optionally include one or more of the following features. The computer-implemented method can further include providing, by the mobile computing device and to the computer system, location updates as the mobile computing device travels with the user to the particular provider's location; receiving, by the mobile computing device and from the computer system, status information for pick-up of the food order; and outputting, by the mobile computing device and through the user interface, one or more user interface features based on the status information. The status information can include information indicating that, as a result of a route being travelled by the user to the particular provider's location, the estimated time of arrival has deviated by at least a threshold amount of time. The one or more user interface features can be selected based on the estimated time of arrival having deviated by at least the threshold amount of time. The one or more user interface features can include selectable features for modifying or cancelling the food order. The computer-implemented method can further include receiving, through at least a portion of the user interface features, input instructing the food order to be modified or cancelled; and providing, by the mobile computing device and to the computer system, instructions to modify or cancel the food order based on the user input.

In another implementation, a computer system can include an interface that is programmed to (i) receive, from mobile computing devices, food orders that specify one or more items to be fulfilled by particular providers and picked-up by users of the mobile computing devices, and (ii) provide food order instructions to provider computer systems associated with the particular providers; a location module that is programmed to (i) determine current locations of the mobile computing devices and (ii) identify locations of the particular providers; an arrival estimation module that is programmed to determine estimated times of arrival for the users to travel from the current locations of the mobile computing devices to the locations of the particular providers; and a fulfillment planning subsystem that is programmed to (i) identify, for the food orders, fulfillment time periods that correspond to lengths of time for the items to be fulfilled as part of the food orders, (ii) determine future times at which the particular providers are to begin preparing the items so that the food orders will be fulfilled and available for pick-up within a threshold period of time of the users arriving at the particular providers' locations, and (iii) generate food order instructions for the particular providers based, at least in part, on the food orders and the future times. The futures times can be determined based, at least in part, on the estimated times of arrival and the fulfillment time periods.

Certain implementations may provide one or more advantages. For example, providers can be provided with greater insights about timing for preparing food items, which can help them to improve customer satisfaction, to decrease wasted resources (e.g., employee time, spoiled products, storage space for food orders awaiting customer arrival), and/or to create greater efficiencies.

The details of one or more embodiments are set forth in the accompanying drawings and the description below. Other features and advantages will be apparent from the description and drawings, and from the claims.

### DESCRIPTION OF DRAWINGS

FIG. 1 is a conceptual diagram of an example system for determining and using intelligent queueing information in the fulfillment of food orders.

FIG. 2 depicts an example system for providing intelligent queueing information for food orders to provider computer systems.

FIGS. 3A-D are flowcharts of an example technique for determining and providing intelligent queueing information to provider computer systems.

FIGS. 4A-B a flowchart of example techniques for using intelligent queueing information to fulfill food orders from a customer device perspective and a provider computer system perspective, respectively.

FIG. 5 is a block diagram of an example system for providing suggested orders.

FIG. 6 illustrates a schematic diagram of an exemplary generic computer system.

Like reference symbols in the various drawings indicate like elements.

### DETAILED DESCRIPTION

This document generally describes techniques, systems, program products, and computing devices for generating intelligent order queuing information that can be used for providers and/or for customers. For example, providers can receive information that indicates when customers are likely to arrive at the providers' locations to pick-up/consume food orders, which providers can use to prioritize their fulfilment queues. In other examples, customers can receive information that can indicate when food orders are likely to be ready at the providers with which they have placed food orders, which customers can used to determine timing for their travel to the providers' locations.

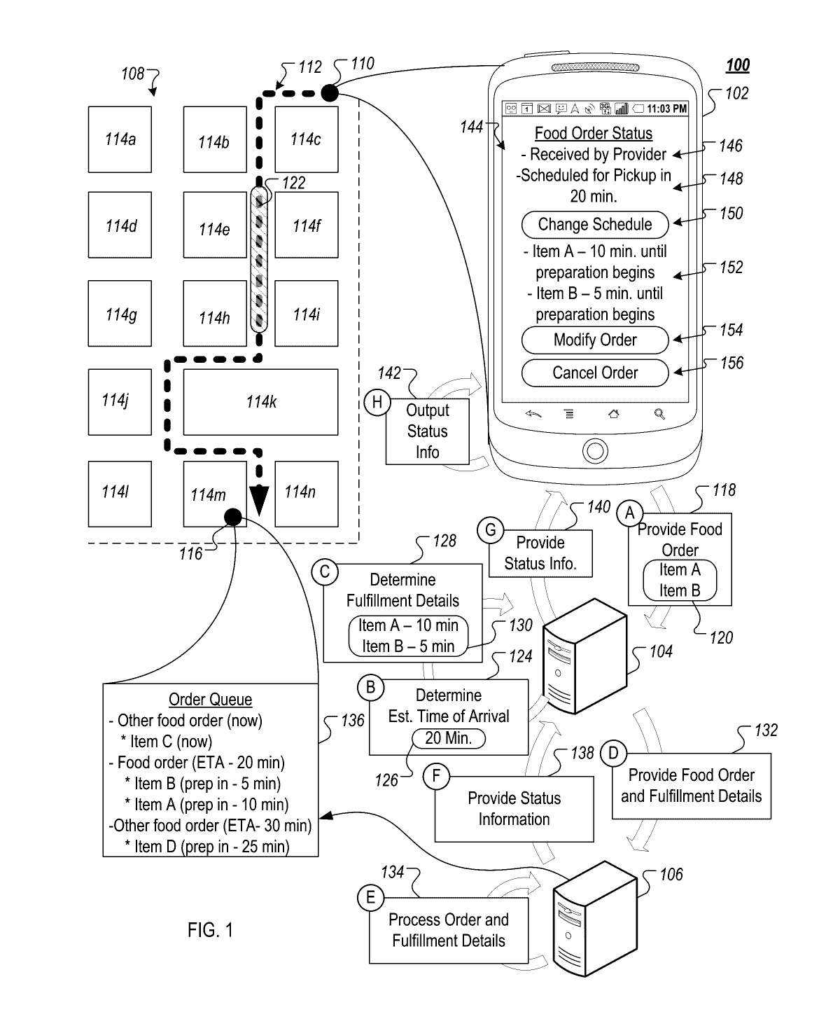

FIG. 1 is a conceptual diagram of an example system 100 for determining and using intelligent queueing information in the fulfillment of food orders. The example system 100 includes an example mobile computing device 102 that can provide food orders to a computer system 104, which can determine intelligent queueing information that can be used by an example provider computer system 106.

The mobile computing device 102 can be any of a variety of appropriate mobile computing devices, such as smartphones, tablet computing devices, personal digital assistants (PDA), media players, laptops, wearable computing devices (e.g., GOOGLE GLASS, MICROSOFT HOLOLENS), navigational computing devices (e.g., automobile navigational systems), and/or other appropriate mobile computing devices. The computer system 104 can be any of a variety of appropriate computer systems, such as server systems, cloud-based computer systems, and/or any other appropriate collection of one or more computing devices. The provider computer system 106 can be any of a variety of appropriate computer devices and/or systems, and can be similar to the mobile computing device 102 and/or the computer system 104. In some implementations, the provider computer system 106 can include one or more computing devices that are used by a provider to take, fulfill, and manage orders, such as point of sale (POS) terminals, devices for tracking and displaying orders for workers, inventory management systems, and/or other appropriate computing devices. The provider system 106 can additionally be part of a network of affiliated provider systems, such as providers that are part of a franchise of providers. The provider computer system 150 can manage a variety of details for associated providers, such as order processing, inventory management, staffing, payment processing, point of sale terminals, and/or other appropriate features.

The mobile computing device 102, the computer system 104, and the provider computer system 106 can communicate over one or more communication networks, such as the internet, wireless networks (e.g., Wi-Fi networks, mobile data networks), local area networks (LAN), wide area network (WAN), virtual private networks (VPN), or any combination thereof.

An example map 108 is depicted showing a current location 110 of the mobile computing device 102 as it travels along portions a route 112 in an area with blocks 114a-n. An example provider 114m (e.g., restaurants, coffee shops, fast food chains, retailers) is depicted as being at location 116 of block 114m. As indicated by example step A (118), the mobile computing device 102 can provide an example food order 120 to the computer system 104. As depicted, the example food order 120 includes example items A and B. The food order 120 can be provided by the mobile computing device 102 in response to user input received by the mobile computing device 102, such as the user entering an order through an application (e.g., mobile app, web browser, web-based application) that is running on the mobile computing device 102.

The computer system 104 can receive the food order 120 and can perform operations to determine intelligent queue information for the order 120. For example, the computer system 104 can determine an estimated time of arrival for the mobile computing device 102 (and/or a user of the mobile computing device 102), as indicated by step B (124). The computer system 104 can determine the estimated time of arrival based on a variety of factors, such as the current location 110 of the mobile computing device 102, the location 116 of the provider that is going to fulfill the food order 120, an estimated route 112 along which the mobile computing device 102 is likely to travel to the provider's location 116, an estimated time for the user of the mobile computing device 102 to travel to the location 116 along the route 112, current and/or estimated transit delays 122 (e.g., traffic, mass transit delays, weather events) along the route 112, historical travel times for users (e.g., user of the mobile computing device 102, other users) along the route 112, historical routes travelled by the user of the mobile computing device 102, time of day, day of the week, information for the user of the mobile computing device 102 (e.g., electronic calendar, social media content, electronic messages), and/or other appropriate factors.

For example, the computer system 102 can use the current location 110 of the mobile computing device 102, the location 116 of the provider to determine that the mobile computing device 102, and historical travel patterns for the user (e.g., user generally drives car at the current time of day, user prefers city streets to highways, user has previously travelled between the locations 110 and 116 using the route 112) is likely (e.g., at least threshold probability, route with top ranked probability) to travel along the route 112. The computer system 102 can then determine a base travel time between the locations 110 and 116 along the route 112. Such a determination can be based on characteristics for the route 112 (e.g., speed limits, number of stop lights, number of stop signs) and/or historical travel times along the route 112 (e.g., historical travel times for the user, historical travel times at a similar time of day and day of the week, historical travel times using the same or similar mode of transportation, historical travel times under similar travel conditions). The computer system 104 can augment the base travel time based on events that are occurring along the route 112 that may affect, positively or negatively, the travel time along the route 112, such as traffic delays, light traffic conditions, weather delays, and/or mass transit (e.g., bus, subway) delays. For instance, in the depicted example the computer system 102 can determine a base travel time for the mobile computing device 102 of 15 minutes, but may increase the travel time by 5 minutes based on the transit delay 122 that is depicted along the route 112, to generate the example estimated time of arrival 126.

A variety of data sources can be accessed by the computer system 104 to estimate the time of arrival for the mobile computing device 102, such as electronic map and route data sources, traffic data sources, location data sources, historical location and travel data sources, weather data sources, user information sources, and/or other appropriate data sources. Such data sources may be maintained by the computer system 104, the mobile computing device 102, and/or other third party computer systems. A user of the mobile computing device 102 may need to grant permission to the computer system 104 to access one or more of the data sources.

For example, in some implementations the mobile computing device 102 can determine its current geographic location and provide it to the computer system 104 in association with the food order 120. A user of the mobile computing device 102 may need to have authorized (e.g., standing authorization, one-off authorization) the transmission of the location information to the computer system 104. The mobile computing device 102 can use any of a variety of appropriate techniques to determine its geographic location, such as GPS techniques, Wi-Fi signals, cellular triangulation, beacon signals, user input, or any combination thereof. The location information that is determined by the mobile computing device 102 can be any of a variety of information that can, with at least a minimum level of granularity, identify the location 110, such as GPS coordinates, the identities of nearby computing devices (e.g., Wi-Fi routers, cell towers), and/or a physical address of the location 110 (e.g., street address, zip code, city).

In some implementations, the location 110 of the mobile computing device 102 is determined by a system that is remote from the mobile computing device 102, such as a data or cellular network provider that is able to triangulate the location 110 through the use of a grid of transceivers located near or around the location 110. A user of the mobile computing device 102 may provide authorization for the computer system 104 to have access to this location information that is determined by a remote system.

The computer system 104 can additionally determine other intelligent queue information. For example, the computer system 104 can determine details regarding fulfillment of the items in the order 120, as indicated by step C (128), such as timing when the provider should begin preparing food order 120 and/or its component parts (e.g., items A and B) so that the food order 120 is ready when the user of the mobile computing device 102 arrives at the provider's location 116. The computer system 104 can determine fulfillment details based on any of a variety of factors, such as the estimated time of arrival 126, estimated lengths of time that it will take the provider to prepare the food order 120 and/or its component parts (e.g., items A and B), the provider's current order queue that is being fulfilled by the provider, estimated/expected additional orders that the provider will receive with a threshold amount of time, historical food order fulfillment times, historical staffing levels at the provider as correlated with historical food order fulfillment times, current staffing levels at the provider, and/or other appropriate factors.

For example, the computer system 104 can take determine a base time to prepare each of the items in the food order 120 and can augment that base time in response to factors that would increase or decrease the amount of time required for the provider to fulfill the food order. For instance, the provider can have a list of standard fulfillment times for each of the items that the provider offers and the provider can provide the computer system 104 with access to that list. The computer system 104 can identify fulfillment times for the items included in the food order 120 and determine a base fulfillment time. The computer system 104 can then increase or decrease the fulfillment times for the food order 120 based on any of a variety of factors that may positively or negatively impact fulfillment times, such as current order volume and staffing levels at the provider. The computer system 104 can determine a single estimated fulfillment time for the food order 120 and/or individual estimated fulfillment times for each of the items included in the order 120. For example, fulfillment times of 10 minutes and 15 minutes can be determined for the items A and B, respectively, which can indicate that it is likely to take the provider 10 minutes to fulfill item A and 15 minutes to fulfill item B.

Any of a variety of data sources can be used by the computer system 104 to determine the fulfillment times, such as a standard fulfillment time data source, a current order volume data source, a current staffing level data source, and/or other appropriate data sources. The data sources can be maintained by the computer system 104, the provider computer system 106, and/or other third party computer systems. Access to the data sources by the computer system 104 can be local and/or remote.

The computer system 104 can additionally combine the estimated fulfillment times with the estimated time of arrival to identify one or more future times at which the provider should begin preparing the food order 120. The future times can be determined in a variety of ways. For example, the computer system 104 subtract the fulfillment times from the estimated time of arrival to determine the future times. Using the example above, that means that fulfillment of item A should be scheduled to begin in 10 minutes (20 minute estimated time of arrival−10 minute fulfillment time for item A) and that fulfillment of item B should be scheduled to begin in 5 minutes (20 minute estimated time of arrival−15 minute fulfillment time for item B), as indicated by example future fulfillment times 130. Such fulfillment times can be correlated to actual times based on the current time. For instance, if the current time is 5:00 pm, then fulfillment of item A can be scheduled for 5:10 pm and fulfillment of item B can be scheduled for 5:05 pm.

The computer system 104 can provide the food order along with the fulfillment details (e.g., estimated time of arrival, future times for fulfillment to begin) to the provider computer system 106, as indicated by step D (132). The provider computer system 106 is programmed to process the order and fulfillment details, as indicated by step E (134). Processing the order and fulfillment details can include inserting the food order 120 (and/or its component parts) into one or more appropriate locations in one or more order queues that are used by the provider computer system 106. For example, the provider may have separate cold and hot food preparation stations that each have different queues, and may have a beverage station that has another separate order fulfillment queue. For example, the computer system 106 can be programmed to position the items A and B from the food order 120 at appropriate locations in the queue(s), which may involve placing the items A and B ahead of other items that were received with orders placed before the food order 120 but which have later fulfillment times.

An example order queue 136 is depicted. In this example, a first order with one item (item C) is depicted as being currently undergoing fulfillment for a customer who is already present at the provider's location 116; the food order 120 is depicted next with the items A and B along with the estimated time of arrival (20 minutes) and the future preparation times (10 minutes for item A and 5 minutes for item B); and another food order for a customer that is estimated to arrive in 30 minutes for an order that includes item D, for which preparation should begin in 25 minutes. The food order 120 can be positioned above the last food order, even though the food order 120 may have been received after the bottom food order based on the estimated times of arrival and/or the times at which fulfillment should begin. The items in the queue 136 can be ordered by the provider computer system 106 in chronological order so that a worker can simply fulfill items in the order presented (and at the times identified) to ensure appropriate and timely fulfillment of the orders. For example, the item B is ordered above the item A within the food order 120 based on item B needing to begin being fulfilled sooner (in 5 minutes of the current time) than item B (in 10 minutes of the current time).

In some implementations, the provider computer system 106 may receive only the estimated time of arrival from the computer system 104 and may determine the fulfillment details and appropriately order the items within the order queue 136. In other implementations, the computer system 106 may order the food orders in the queue 136 based only on the estimated time of arrival. In some implementations, the provider computer system 106 may receive both estimated times of arrival and fulfillment details, and may augment the fulfillment details based on information that is accessible to the computer system 106, such as current order volume and/or current/projected staffing levels at various times.

The provider computer system 106 can provide status information for fulfillment of the order to the computer system 104, as indicated by step F (138). The status information can include a variety of information regarding fulfillment of the order 120, such as confirmation that the food order 120 has been received by the provider, confirmation that the provider has scheduled the food order 120 for fulfill at the estimated time of arrival for the user of the mobile computing device 102, and/or information on future times when fulfillment is scheduled to begin (e.g., as determined and/or modified by the computer system 106).

The computer system 104 can receive the status information, store it, and provide it to the mobile computing device 102, as indicated by step G (140).

The mobile computing device 102 can receive the status information and can output it, as indicated by step H (142). For example, the mobile computing device 102 can output a user interface 144 that can include the status information as well as one or more control features through which a user can further modify/cancel details regarding the order 120. For instance, the interface 144 includes first information 146 indicating that the food order 120 has been received by the provider, second information 148 indicating the estimated time when the user will arrive at the provider's location 116, a first user control feature 150 that a user can select to change/designate a time of arrival at the provider's location 116 (e.g., override the automatically determined estimated time of arrival), third information 152 indicating when preparation of the items in the food order 120 is scheduled to begin (and/or indicating whether preparation/fulfillment has begun), a second control feature 154 that a user can select to modify the food order 120, and a third control feature 156 that a user can select to cancel the food order 120. Other information and/or control features can also be presented.

Selection one or more of the control features 150, 154, and 156 can cause the mobile computing device 102 to transmit a request that corresponds to the selected feature and that is associated with the food order 120 to the computer system 104. Such a request can cause the computer system 104 to re-perform one or more of the steps B-D (124, 128, 132) based on the request, and can cause the provider computer system 106 to repeat one or more of the steps E-F (134, 138) based on the request. For example, selection and input of schedule information using the feature 150 to change the schedule (e.g., make the time of arrival earlier, make the time of arrival later) can be relayed to the computer system 104, which re-perform step C (128) to determine updated fulfillment details based on the arrival time designated by the user of the mobile computing device 102. This can, in turn, cause the computer system 104 to provide updated fulfillment details to the computer system 106, which can use the updated arrival time and updated fulfillment details to appropriately update the order queue 136 and corresponding fulfillment of the order 120. Similarly, selection of the feature 154 to modify the order (e.g., add items, remove items, change quantities and/or options) can cause the computer system 104 to re-perform the step C (128), which can cause the computer system 106 to re-perform step E (134). Selection of the feature 156 can be received by the computer system 104 and forwarded to the computer system 106, which can cause the computer system 106 to remove the food order 120 from the order queue 136 and to stop fulfillment of the order 120.

In some implementations, the mobile computing device 102 and/or the computer system 104 are programmed to restrict schedule changes, order modifications, and/or order cancellations through the control features 150, 154, and 156, respectively, to instances when the provider has not yet begun fulfilling the food order 120 (or has progressed less than a threshold amount through fulfillment of the food order 120). In some implementations, use of the control features 150, 154, and 156 that may cause fulfillment of the order to not be completed by the time the user is estimated to arrive at the provider's location 116, such as moving-up the time of arrival, can cause the mobile computing device 102 to output a warning in the user interface 144 regarding the effects of the requested change. A user may be able to dismiss such a warning and proceed, or may be able to cancel the proposed action before it is transmitted to the computer system 104 and/or the computer system 106.

The computer system 104 can additionally receive location updates for the mobile computing device 102 as it travels to the provider's location 116 and, as appropriate, can re-perform steps B-D (124, 128, and 132), which can cause the provider computer system 106 to re-perform steps E-F (134, 138). For example, if the computer system 104 determines that the estimated time of arrival has deviated by at least a threshold amount of time (e.g., changed by more than 1 minute, 2 minutes, 5 minutes, 10 minutes) based on the movement of the mobile computing device 102 (e.g., not tracking estimated progress along the route 112, deviation from route 112), then the computer system 104 can update the estimated time of arrival (step B, 124) and the fulfillment details (step C, 128), which can be provided to the provider computer system 106 (step D, 132) and used by the provider computer system 106 to update the order queue 136 and fulfillment of the food order 120 (step E, 134). Additionally, such detected deviations that are likely to affect fulfillment of the food order 120 can be relayed by the computer system 104 to the mobile computing device 102, such as warnings that the deviation will cause the food order 120 to be fulfilled at least a threshold amount of time before the user arrives at the location 112 and/or control features through which the user can cancel the order (e.g., control feature 156), designate a specific arrival time (e.g., control feature 150), change from pickup/dine-in to delivery for the food order 120, and/or select a different provider to fulfill the order (e.g., provider closer to the current location of the mobile computing device 102).

Warnings can also be provided to the mobile computing device 102 when the computer system 104 determines that the estimated time of arrival is less than the fulfillment time for the food order 120. Similar warnings/options can be provided to the mobile computing device 102 as discussed in the previous paragraph in such instances (e.g., cancel order, proceed with order even though food order 120 will not be ready at arrival, designate specific arrival time, change to delivery, switch providers).

In some implementations, a user who places the food order 120 can be different from the user who is associated with the mobile computing device 102 that is travelling to the provider's location 116. For example, a user who places the order may be able to provide a unique identifier (e.g., email address, telephone number, social network identifier, username) for another user and/or mobile computing device that will be travelling to the provider's location 116, and the location of that mobile computing device can be used by the computer system 104 to determine the estimated time of arrival and fulfillment details.

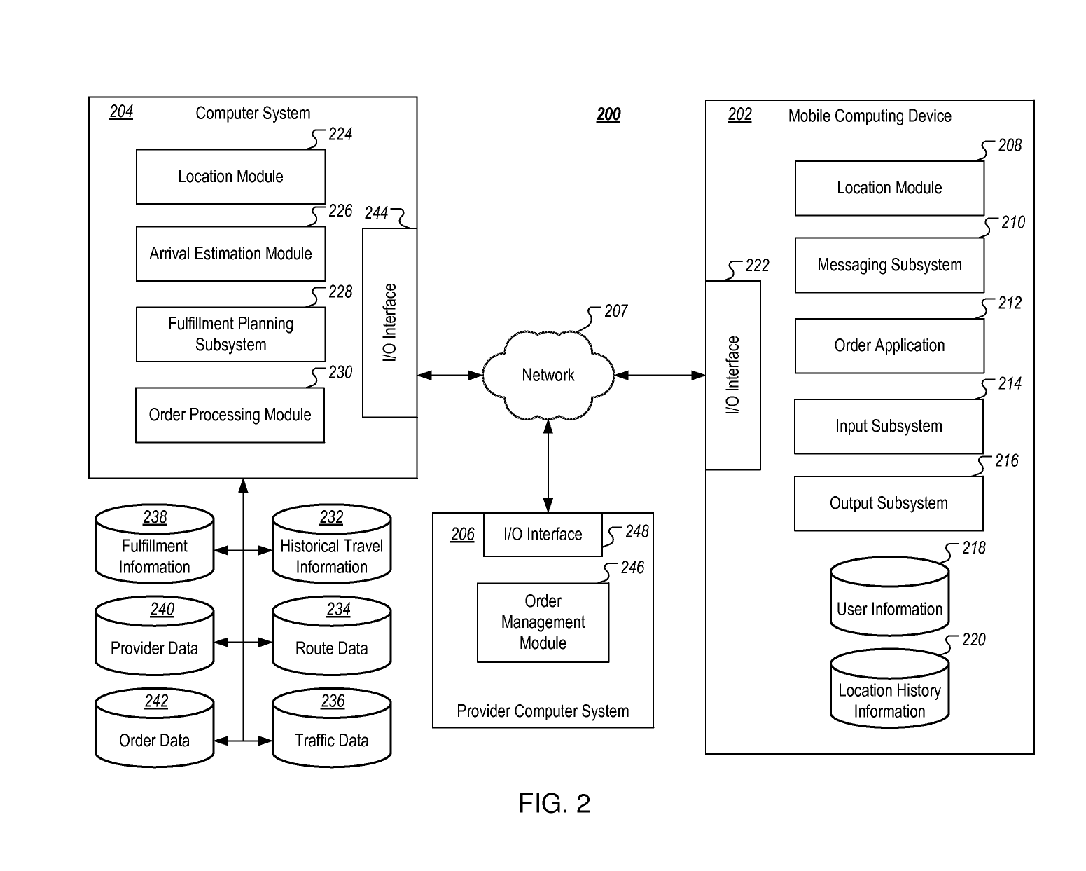

FIG. 2 depicts an example system 200 for providing intelligent queueing information for food orders to provider computer systems. The example system 200 can be similar to the system 100 described above with regard to FIG. 1. The system 200 includes a mobile computing device 202 that provides orders to a computer system 204, which determines fulfillment details and estimated times of arrival, and communicates them to a provider computer system 206 over a communications network 207. The mobile computing device 202 and/or the computer system 204 can be similar to the mobile computing device 102 and/or the computer system 104, respectively.

The mobile computing device 202 can be similar to the mobile computing device 102 and can be any of a variety of appropriate mobile computing devices, such as a smartphone, a tablet computing device, and/or wearable computing device. The mobile computing device 202 includes a location module 208 that is programmed to determine a current location for the mobile computing device 202. The location module 208 can include and/or access components, such as GPS and/or Wi-Fi components. Locations identified by the location module 208 can be transmitted to the computer system 204 and can be used by the computer system 204 to determine whether to provide order suggestions to the mobile computing device 202.

The mobile computing device 202 also includes a messaging subsystem 210 that can be programmed to send, receive, output, and/or create messages on the mobile computing device 202. For instance, the messaging subsystem 210 can be text messaging application and/or a push notification subsystem that are running on the mobile computing device 202. The computer system 204 may communicate some order information and/or fulfillment details (e.g., warnings) to the mobile computing device 202 via text messages.

The mobile computing device 202 can additionally include an order application 212 that is programmed to manage placed orders on the mobile computing device 202. For example, the order application 212 can be, for instance, a mobile app that is programmed to receive food orders, transmit them to the computer system 204, and present status information for the orders, such as in the example user interface 144. The order application 212 can use an input subsystem 214 and an output subsystem 216 that are part of the mobile computing device 202 to receive orders and output order information and updates. The input subsystem 214 can include any of a variety of components through which a user can provide input, such as touchscreens, keyboards, physical buttons, cameras, microphones, accelerometers, gyroscopes, magnetometers, and/or other appropriate input devices. The output subsystem 216 can include any of a variety of components through which a user can provide output, such as displays, speakers, haptic feedback devices, and/or other appropriate output devices.

The mobile computing device 202 can locally store information that may be used to determine and provide intelligent queueing information, such as user information 218 and/or location history information 220. The user information 218 ca include information about a user that may indicate any of a variety of details that may inform routes and/or travel patterns that a user may use, such as social network information (e.g., comments, posts), electronic calendar information, transit purchase history, and/or other appropriate factors. The location history information 220 can be a log of locations that the mobile computing device 202 has been, including information that can be used to determine routes that the mobile computing device 202 has traveled. With the user's consent, the information 218 and/or 202 can be provided to and used by the computer system 204.

The mobile computing device 202 includes an input/output (I/O) interface 222 that is configured to transmit and receive information over the network 206. The I/O interface 222 can be any of a variety of appropriate interfaces, such as wired and/or wireless communication interfaces. The network 207 can be any of a variety appropriate communication networks, such as the internet, wireless networks, wired networks, or any combination thereof.

The computer system 204 includes a location module 224 that is programmed to determine and track the location of the mobile computing device 202 when orders are submitted and as the mobile computing device 202 travels to provider locations. The location module 224 can additionally be programmed to determine routes along which the mobile computing device 202 is likely to travel, and to detect deviations from the estimated routes and/or progression along those routes. For example, the location module 224 can use the location information determined by the location module 208, historical travel information for the mobile computing device 202, and/or provider location information to identify candidate routes along which the mobile computing device 202 is likely to travel to a provider's location.

The computer system 204 additionally includes an arrival estimation module 226 that is programmed to determine estimated times when the mobile computing device 202 will arrive at a provider's location (similar to step B, 124). The arrival estimation module 226 can use any of a variety of appropriate factors to make such determinations, such as the estimated routes, location history information 220 for the mobile computing device 202, historical travel data 232 (for the user of the mobile computing device 202 and/or other users), route data 234, and/or traffic data 236. Other data sources and information can also be used, such as time and date information (e.g., time of day, day of the week, time of year), and/or external factors (e.g., current weather).

The computer system 204 additionally includes a fulfillment planning subsystem 228 that is programmed to determine fulfillment details for food orders (similar to step C, 128). The fulfillment planning subsystem 228 can determine fulfillment details based on any of a variety of appropriate factors, such as standard fulfillment information for providers 238 and/or provider data 240 that can indicate current volumes of orders and/or staffing at providers. Other factors are also possible.

The computer system 204 can further include an order processing module 230 that can process orders that are placed by the mobile computing device 202, such as orders placed by a user of the mobile computing device 202 and that are then provided to the provider computer system 206 with fulfillment details and estimated arrival information. The order processing module 230 can store and track order data 242, which may be modified and/or cancelled at a later time by users.

The computer system 204 also includes an I/O interface 244 that transmit and receive information over the network 206.

The system 200 additionally includes a provider computer system 206 that can be similar to the provider computer system 106. The provider computer system 206 includes an order management module 246 that is programmed to receive orders, manage the fulfilment of orders (e.g., place in appropriate queues for completion of the order, order queues according to fulfillment details and/or estimated times of arrival), and communicate status information regarding the orders. The provider computer system additionally includes an I/O interface 248 that can be similar to the I/O interfaces 222 and 244.

Although one of each of the entities 202, 204, and 206 is described, the system 200 can include multiples of each of the entities 202, 204, and 206. Additionally, the modules and components described for the entities 202, 204, and 206 can be implemented in any of a variety of ways, such as through software (e.g., applications, operating system process), hardware (e.g., application specific integrated circuit (ASIC)), firmware, or any combination thereof.

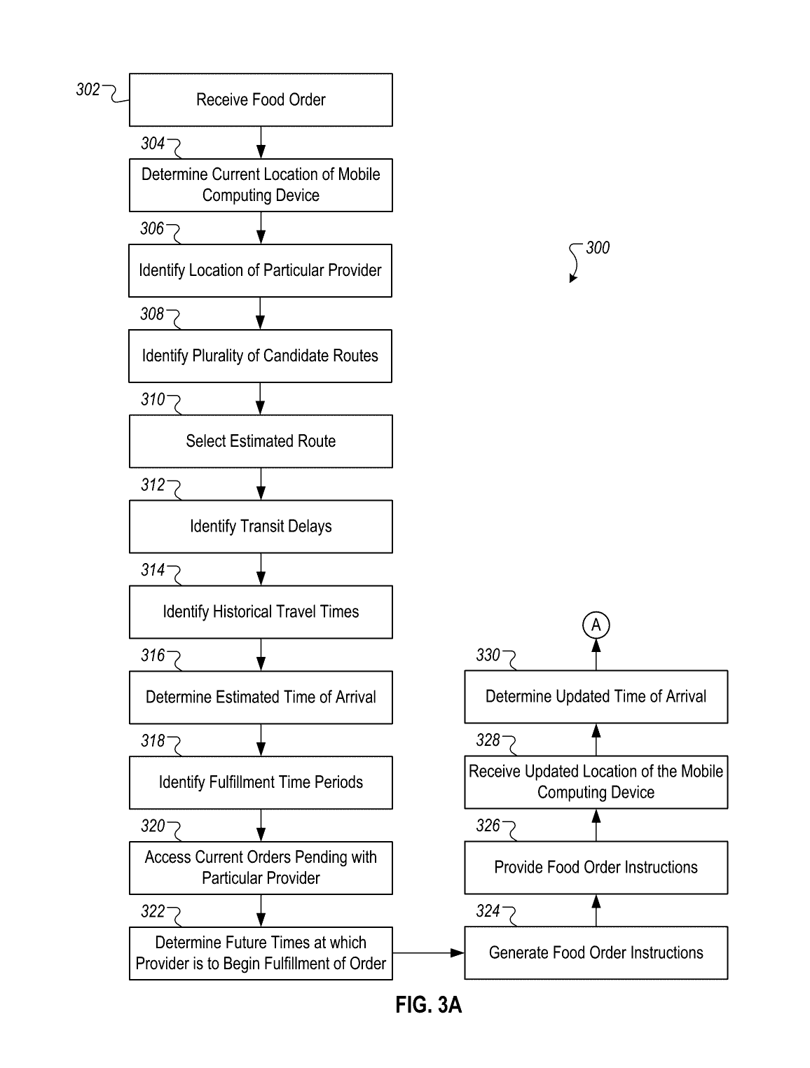

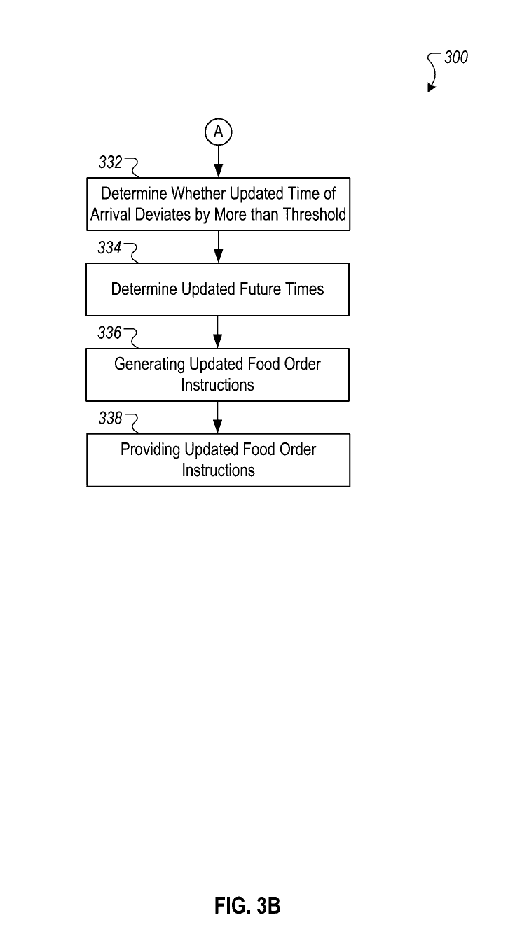

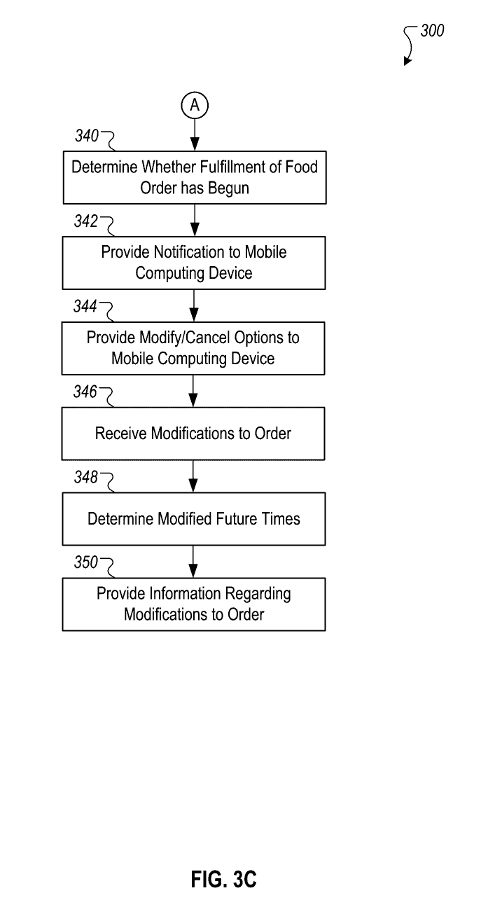

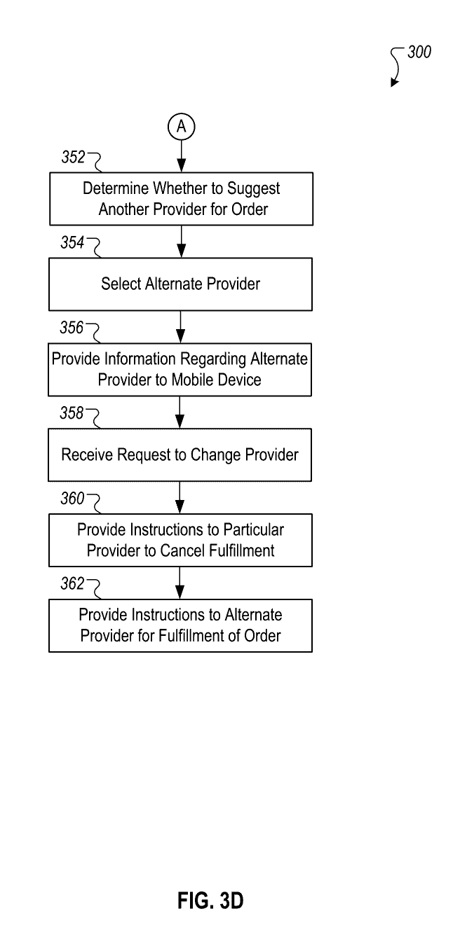

FIGS. 3A-D are flowcharts of an example technique 300 for determining and providing intelligent queueing information to provider computer systems. The example technique 300 can be performed by any of a variety of appropriate computer systems and/or computing devices, such as the computer system 104 and/or the computer system 204. In some implementations, the example technique 300 may additionally be performed locally by a mobile computing device, such as the mobile computing devices 102 and/or 202.

Referring to FIG. 3A, food orders can be received (302). For example, the interface 244 of the computer system 204 can receive a food order from the mobile computing device 202. In response to receiving the food order, a current location of the mobile computing device can be determined (304), a location of a particular provider identified in the food order can be identified (306), a plurality candidate routes for travelling between the two locations can be identified (308), and an estimated route that the user is most likely to use to travel between the locations can be selected (310). For example, the location module 224 of the computer system 204 can determine the locations, identify a number of possible candidate routes that the user could take to travel between the locations, and, based on a variety of factors (e.g., historical travel information for the user, historical travel information for other users), can select a particular route that appears to be the route the user is most likely to take.

Transit delays can be identified (312), historical travel times can be identified (314), and an estimated time of arrival for the user at the location of the particular provider can be determined (316). For example, the arrival estimation module 226 of the computer system can access traffic data 236 and historical travel information 232 for the estimated route, and can determine an estimated time when the mobile computing device 202 will arrive at the location of the particular provider.

Fulfillment time periods can be identified (318), current orders that are pending with the particular provider can be accessed (320), and future times at which the provider is to begin fulfilling the order can be determined (322). For example, the fulfillment planning subsystem 228 of the computer system 228 can access fulfillment information 238 that indicates standard times to fulfill items contained within the order, provider data 240 that indicates the current status of one or more order queues used by the particular provider, and can determine one or more future times at which items and/or the order in its entirety should be scheduled for fulfillment by the particular provider to ensure that it is available within a threshold period of time of the user arriving at the provider's location.

Food order instructions can be generated (324) and provided to a provider computer system (326). For example, the order processing module 230 of the computer system 204 can collect the estimated arrival information and the fulfillment details (e.g., future times) and can provide them to the provider computer system 206.

Updated location information for the mobile computing device can be received (328) and an updated time of arrival can be determined (330). For example, the location module 224 of the computer system 204 can track the progression of the mobile computing device 202 as it travels to the provider's location and can update the estimated time of arrival based on the progress made toward the provider's location. Such updated arrival information can be used to determine whether the mobile computing device 202 is ahead of schedule, on schedule, or behind schedule, and can be used to inform the provider computer system 206 as to adjustments that should be made to the fulfillment of the food order (e.g., hold on fulfillment for a period of time longer, rush fulfillment of food order), and/or to inform the mobile computing device 202 its travel progress will have on the order being fulfilled upon arrival at the provider's location.

FIGS. 3B-D depict different portions of the technique 300 that can be performed alone or together based on the updated time of arrival information. FIG. 3B depicts a portion of the technique 300 that involves providing updated food order instructions. FIG. 3C depicts a portion of the technique 300 that involves a food order having already begun being fulfilled. FIG. 3D depicts a portion of the technique 300 that involves selecting an alternate provider to fulfill the food order. The portions of the technique 300 in FIGS. 3B-D can be performed in various combinations, such as through combining their subparts with each other.

Referring to FIG. 3B, a determination of whether the updated time deviates by more than a threshold amount (e.g., 1 minute, 2 minutes, 5 minutes) from the original time estimate can be made (332). For example, the arrival estimation module 226 can determine whether the updated time of arrival has deviated from the original estimate by a sufficient amount so as to warrant updating the future times and food order instructions provided to the provider computer system 206. In response to determining that the time of arrival has deviated by at least a threshold amount, a updated future times can be determined (334), such as by the fulfillment planning subsystem 228; updated food order instructions can be generated (336) and provided to the provider computer system (338), such as by the order processing module 230.

Referring to FIG. 3C, a determination can be made as to whether fulfillment of the food order by the provider has begun (340). For example, the order processing module 230 can poll the provider computer system 206 to obtain status information for the order, including information indicating whether fulfillment has begun. In another example, the order processing module 230 can determine whether the provider has begun fulfilling the order based on a comparison of the current time and the future times that were determined by the fulfillment planning system 228 and provided to the provider computer system 206. In response to determining that the fulfillment has begun, a notification can be provided to the mobile computing device (342) and/or options to modify/cancel the order can be provided (344). Steps 342 and/or 344 may be performed in response to determination that the time of arrival has deviated from the originally estimated time of arrival (e.g., step 332). Modification of the order can be received (346), future times for fulfillment of the modified portions of the order can be determined (348), and provided to the provider computer system (350). For example, the fulfillment planning system 228 can determine updated future times for fulfilling the modified order and the order processing module 230 can provide the updated future times to the provider computer system 206.

Steps 342-350 can be performed at any of a variety of other parts of the technique 300. For example, steps 342-350 may be performed after step 326. Other locations for the performance of steps 342-350 are also possible.

Referring to FIG. 3D, a determination is made as to whether to suggest another provider to fulfill the order (352). For example, if the mobile computing device 202 has deviated so far off course that it is now located closer to a different provider that could fulfill the order (e.g., another restaurant that is part of a chain of restaurants with which the order was placed), the computer system 204 can determine that it is appropriate to suggest the different provider. An alternate provider can be selected (354) and information about the alternate provider can be provided to the mobile computing device (356). In response, a request to change from the particular provider to the alternate provider for fulfilling the order can be received (358) and instructions can be provided to both the particular provider (360) and the alternate provider (362) regarding the change.

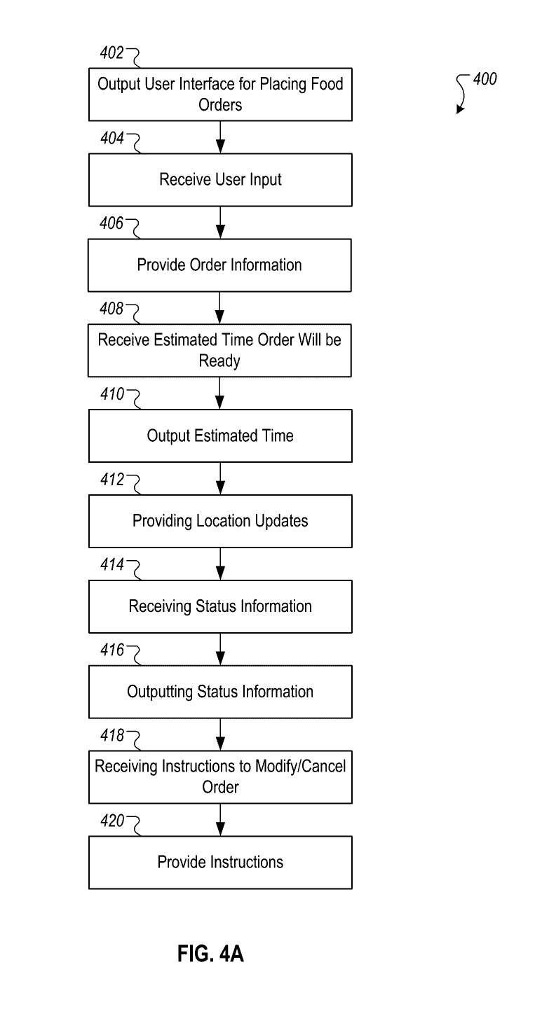

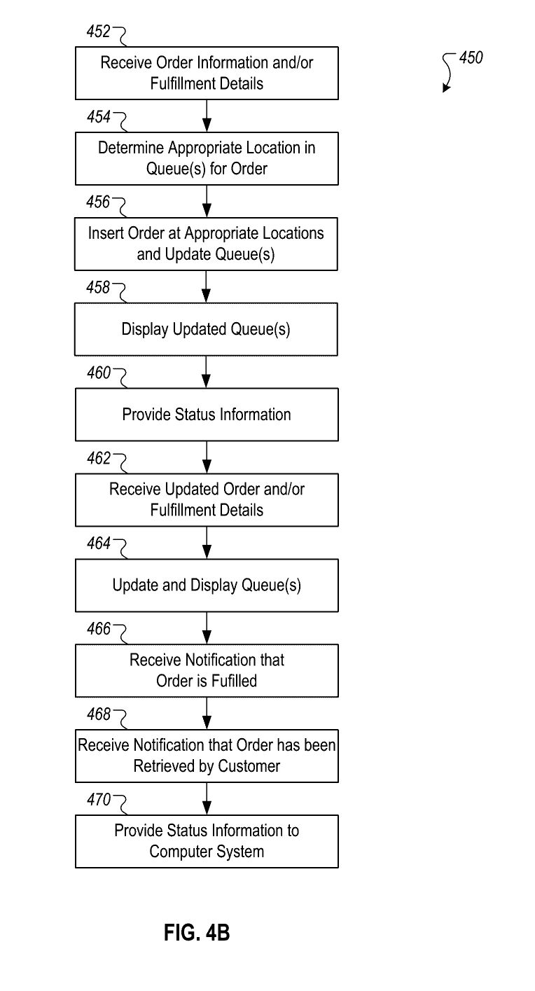

FIGS. 4A-B a flowchart of example techniques 400 and 450 for using intelligent queueing information to fulfill food orders from a customer device perspective and a provider computer system perspective, respectively. The example technique 400 can be performed by any of a variety of appropriate mobile computing devices, such as the mobile computing device 102 and/or the mobile computing device 202. The example technique 450 can be performed by any of a variety of appropriate provider computer systems, such as the provider computer system 106 and/or the provider computer system 206.

Referring to FIG. 4A, a user interface for placing food order can be output (402), input designating a food order can be received (404), and order information can be provided to a computer system (406). For example, the order application 212 can use the input subsystem 214 and the output subsystem 216 to provide a user interface through which items can be selected for a food order and submitted by a user of the mobile computing device 202. In response to placing the order, information identifying an estimated time when the order will be ready/fulfilled by the provider can be received (408) and output (410).

As the mobile computing device travels to the provider's location, location updates can be provided to the computer system (412), which can be used by the computer system (e.g., computer system 204) to determine whether updates to any of the determined estimates are needed. Status information can be received (414) and output (416), such as in the example user interface 144 presented with mobile computing device 102. Instructions to modify and/or cancel the order can be received (418) and provided to the computer system (420).

Referring to FIG. 4B, order information and fulfillment details can be received (452). The order information and fulfillment details can be processed to determine appropriate locations in one or more queues for the order and/or items included in the order (454). For example, the order management module 246 can determine that the a some items from received order should be positioned near the front of a hot food queue and that the remaining items should be positioned at the back of a cold food queue based on the time of arrival of the customer and/or the future fulfillment times for the items and/or the order as determined by the computer system 204. The order can be inserted at appropriate locations within the one or more queues (456) and the display of the queues that is provided by the provider to its workers can be updated (458). With the order initially processed, the provider computer system can report the status (e.g., order received, slotted into queue(s), fulfillment at estimated arrival on track) to the computer system (460).

Updated order and/or fulfillment details can be received (462). For example, the computer system 204 can provide updates based on movement of the mobile computing device 202 (e.g., travelling ahead of schedule, travelling behind schedule) and/or based on explicit input from the user (e.g., designate particular pickup time, modify order). The queue(s) can be updated, as needed, based on the received update information and can be displayed (464).

Notification can be received that the order has been fulfilled (466). For example, a worker may provide input (e.g., clear out order) that indicates that the order has been fulfilled, and the order management module 248 can receive the input. Notification can also be received that the customer has retrieved the order (468). For example, a point of sale terminal can process payment for the order and provide notification that the order has been picked up by the customer. Status information regarding the fulfillment and/or pickup of the order can be provided to the computer system (470).

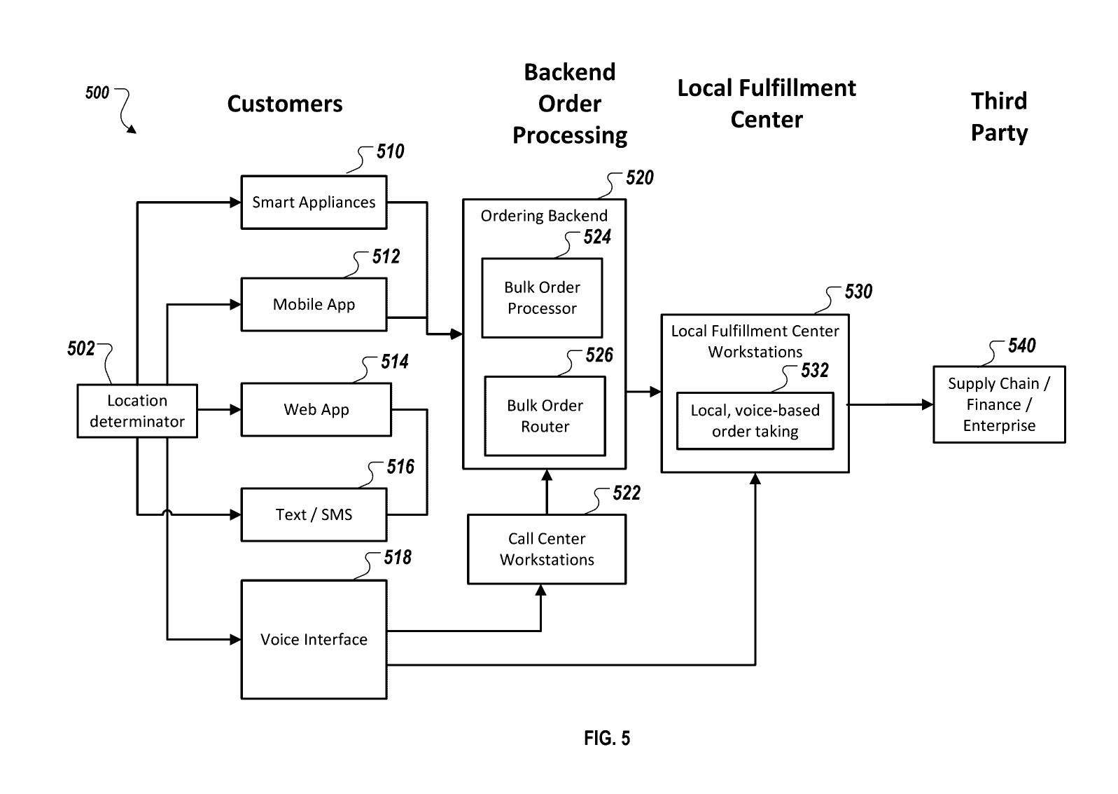

FIG. 5 is a block diagram of an example system 500. Briefly, and as described in further detail below, the system 500 may include a location determinator 502, smart appliances 510, a mobile application 512, a web application 514, a text or short message service (SMS) application 516, a voice interface 518, an ordering backend 520, call center workstations 522, local fulfillment center workstations 530, and a supply chain, finance, or enterprise component 540. The system 500 may provide for real time delivery of an item. Real time delivery may include point-to-point delivery of small, tangible, purchased goods within a very short period of time of purchase, e.g., few minutes to a few hours. Purchased goods may include typical packaged goods that do not otherwise require real-time delivery, e.g., consumer electronics or office supplies, goods that degrade over a long period of time, e.g., groceries or flowers, or goods that degrade within a very short period of time, e.g., dry ice, ice cream, hot pizza or a cup of coffee.

The location determinator 502 may determine location information for a customer. For example, the location determinator 502 may determine a customer's location based on or more of a service set identifier (SSID) of a nearby detected wireless network, a detected phone mast signal, determined global positioning system (GPS) information, an assigned Internet Protocol (IP) address, a landline location, or a wireless media access control (MAC) address. The location determinator 502 may provide the location information to the smart appliances 510, the mobile application 512, the web application 514, the text or short message service (SMS) application 516, and the voice interface 518.

The smart appliances 510, the mobile application 512, the web application 514, the text or short message service (SMS) application 516, and the voice interface 518 may enable a customer to place an order. For example, one or more of the smart appliances 510, the mobile application 512, the web application 514, the text or short message service (SMS) application 516, and the voice interface 518 may enable a customer to place an order for a cheese pizza to be delivered to the customer's home address at 6:00 PM. To enable customers to place orders, the smart appliances 510, the mobile application 512, the web application 514, the text or short message service (SMS) application 516, and the voice interface 518 may provide interfaces through which the customer may specify a particular item to order, and a particular location for which the customer would like to obtain the item. For example, the smart appliances 510, the mobile application 512, the web application 514, the text or short message service (SMS) application 516, and the voice interface 518 may visually or audibly provide prompts to the customer requesting that the customer specify a particular item to order, a particular location to receive the item, and a particular time to receive the item.

More specifically, the smart appliances 510 may be appliances that may be used to place orders. For example, the smart appliances 510 may include a television that may be used by a customer to place an order for a pizza. The smart appliances 510 may provide an interface for a customer to place an order. For example, the smart appliance 510 may include a display that may render an interface for the customer to order a pizza. The smart appliances 510 may provide orders to an ordering backend 520. For example, the smart appliances 510 may provide an order for a pizza through a network to the ordering backend 520.

The mobile application 512 may be an application running on a mobile device that enables a customer to place an order. For example, an application running on a customer's smart phone may enable the customer to place an order for pizza. A mobile device may include a smart phone, a tablet computer, or some other type of computing device that may be portably used. The mobile application 512 may provide an interface for a customer to place an order. For example, the mobile application 512 may display on the mobile device an interface for the customer to order a pizza. The mobile application 512 may provide orders to an ordering backend 520. For example, the mobile application 512 may provide an order for a pizza through a network to the ordering backend 520.

The web application 514 may be an application accessible through a web browser running on a computing device, where the application enables a customer to place an order. For example, a Java application may be rendered by a web browser on a desktop computer and enable a customer to place an order for pizza. A computing device may include a mobile device, a desktop computer, a laptop computer, or some other type of device that computes. The web application 514 may provide an interface for a customer to place an order. For example, the web application 514 may display an interface, in a web browser on a desktop computer, for the customer to order a pizza. The web application 514 may provide orders to an ordering backend 520. For example, the web application 514 may provide an order for a pizza through a network to the ordering backend 520.

The text or SMS application 516 may be an application running on a mobile device that enables a customer to place an order by text or SMS. For example, an application running on a customer's smart phone may enable the customer to send a text or SMS message to the ordering backend 520 to place an order for pizza. In some implementations, the application may provide a graphical user interface for the user to select a particular item, particular location, and a particular time to receive the item, and generate a SMS message indicating the selections and provide the SMS message to the ordering backend 520.

The voice interface 518 may be an interface that enables a customer to place an order by voice. For example, the voice interface 518 may be a telephone that a customer may use to verbally order a pizza. The voice interface 518 may communicate with the call center workstations 522. For example, the voice interface 518 may transmit audio captured by the voice interface 518 to the call center workstations 522, and similarly, output audio from the call center workstations 522. The voice interface 518 may additionally or alternatively communicate with a local voice-based order taking component 532 of a local fulfillment center workstation 530. For example, the voice interface 518 may transmit audio captured by the voice interface 518 to the local voice-based order taking component 532, and similarly, output received audio from the local voice-based order taking component 532.

The call center workstations 522 may receive voice input from the voice interface 518, generate orders based on the voice input, and provide the orders to the ordering backend 520. For example, the call center workstations 522 may audibly output voice input from the interface 518 to allow customer service representatives to verbally interact with customers, and generate orders for the customers. In some implementations, the call center workstations 522 may be automated and use speech recognition to generate orders for users. For example, the call center workstations 522 may execute an Artificial Intelligence customer service agent program that may verbally speak to the customer to take the order and place the order directly for the customer.

The ordering backend 520 may be a component that processes orders from customers. For example, the ordering backend may receive orders from the smart appliances 510, mobile application 512, web application 514, text or SMS application 516, the voice interface 518, or the call center workstations 522. The ordering backend 520 may process orders based on determining, for each order, one or more local fulfillment center workstations 530 to receive the order. For example, the ordering backend 520 may determine that a first order for a pizza should be provided to a first local fulfillment center workstation and a second order for a pizza should be provided to a different, second local fulfillment center workstation.

The ordering backend 520 may determine a local fulfillment center workstation to receive a particular order based on a location which the customer would like to obtain the item ordered. For example, the ordering backend 520 may determine that a first order indicates the order is to be obtained at a location where the distance from the location to the local fulfillment center is within a distance threshold, and in response, determine to provide the first order to a workstation of the local fulfillment center. In another example, the ordering backend 520 may determine that a second order is to be obtained at a location where the distance from the location to the local fulfillment center exceeds a distance threshold, and in response, determine the second order should be provided to a workstation of another local fulfillment center.

Additionally or alternatively, the ordering backend 520 may determine a local fulfillment center workstation to receive a particular order based on availability of the local fulfillment center to fulfill the order. For example, the ordering backend 520 may determine that a first order for a pizza can be fulfilled by a local fulfillment center as the local fulfillment center may still have capacity to provide the pizza. In another example, the ordering backend 520 may determine that a second order for a pizza cannot be fulfilled by a local fulfillment center as the local fulfillment center may not have capacity to provide the pizza.

In response to determining the local fulfillment center workstations 530 to receive an order, the ordering backend 520 may provide the order to the local fulfillment center workstations 530. For example, in response to determining that a local fulfillment center does deliver to the particular location requested by a customer and has capacity to fulfill an order for pizza, the ordering backend 520 may determine to provide the order for pizza to the local fulfillment center workstations 530 of the local fulfillment center.

In processing the orders, the ordering backend may also process payments for the orders. For example, the ordering backend 520 may validate whether payment information provided in the order is correct. In another example, the ordering backend 520 may place charges for orders using payment information provided in the order.

The ordering backend 520 may include a bulk order processor 524. The bulk order processor 524 may enable the ordering backend 520 to perform mass processing of orders. For example, the ordering backend 520 may receive an extremely large number of orders within a given time frame from the smart appliances 510, mobile application 512, web application 514, text or SMS application 516, the voice interface 518, or the call center workstations 522. Processing such an amount of orders may include determining, for each order, one or more local fulfillment center workstations out of thousands of potential local fulfillment center workstations 530 to receive the order.

The ordering backend 520 may also include a bulk order router 526. The bulk order router 526 may enable the ordering backend 520 to perform mass management of logistics, including delivery scheduling and collection scheduling of received orders. For example, the ordering backend may receive an extremely large number of orders within a given time frame from the smart appliances 510, mobile application 512, web application 514, text or SMS application 516, the voice interface 518, or the call center workstations 522. Managing the delivery scheduling or collection scheduling of such an amount of orders may include determining an order preparation schedule for each local fulfillment center workstation.

The ordering backend 520 performs a variety of tasks relating to processing or routing bulk orders, including sorting, assigning, routing, queuing, distributing and scheduling, to name a few. The study, optimization and execution of these tasks requires the uses of techniques and results from well-developed, active areas of scientific research, such as operational research, combinatorial optimization, graph theory (in particular network theory), queuing theory, and transport theory. Executing or providing optimal solutions to such tasks are proven to be complex and mathematically hard, particularly when considering large-scale systems. For example, e-commerce giant Amazon reported that they received, processed and delivered orders for 426 items per second in the run up to Christmas in 2013, see for example http://articles.latimes.com/2013/dec/26/business/la-fi-tn-amazon-sold-426-items-per-second-cyber-monday-20131226.

Since scaling is an extremely important factor, particularly in the context of e-commerce, tasks relating to processing or routing bulk orders quickly become extremely difficult, if not impossible, to solve and require powerful computers implementing complex algorithms and elegant mathematical programming techniques, as well as robust hardware architectures that can be parallelized. In some cases, it has even been shown that many tasks relating to the processing or routing of bulk orders are computationally intractable. In fact, the theory of computational complexity has introduced a concept of NP-hardness to classify such computationally intractable tasks.

For example, consider the intensely studied Traveling Salesman Problem (TSP), an NP-hard problem in combinatorial optimization. In its purest formulation, the TSP may be described as follows: given a list of cities and the distances between each pair of cities, what is the shortest route that visits each city exactly once, and returns to the original city. The TSP may also be modeled and described as a graph problem, wherein the cities are the graph's vertices and the distances between each pair of cities are the lengths of the graph's edges, or formulated as an integer linear program. The TSP has several applications in operational research, including planning and logistics, wherein the concept of a city may represent customers or orders, and the concept of a distance may represent travelling times or incurred costs. In some implementations, additional constraints may be imposed on the TSP, such as limiting an amount of resources or limiting to certain time windows. Finding increasingly efficient solutions to the TSP and other such complex, subtle operational research problems is an active area of scientific research, as evidenced by a plethora of technical textbooks, journals and scientific articles. See, for example “In Pursuit of the Travelling Salesman: Mathematics at the Limits of Computation,” William Cook, Princeton University Press, 2011, “Dynamic programming strategies and reduction techniques for the traveling salesman problem with time windows and precedence constraints,” L. Bianco, A. Mingozzi, and S. Ricciardelli, Operations Research, 45 (1997) 365-377 and “Scheduling vehicles from a central depot to a number of delivery points,” G. Clarke and J. Wright, Operations Research 52 (1964) 568-581.

Another well-studied, fundamental combinatorial optimization problem in the field of operational research and optimization is the Assignment Problem (AP). In its most general form, the AP may be described as follows: given a number of agents, a number of tasks and a set of incurring costs for each potential agent-task assignment, perform all tasks by assigning one agent to each task, and one task to each agent, such that the total costs incurred is minimized. The AP also has several applications in areas such as planning and logistics. For example, the ordering backend 520 may interpret the task of processing received orders as an assignment problem, wherein a local fulfillment center workstation can be assigned to deliver an order, incurring some cost. The bulk order processor 524, for example, may require that all orders are delivered by assigning one local fulfillment center to each order, and one order to each local fulfillment center, in such a way that the total cost of the assignment is minimized. It has been shown that such an assignment problem can be expressed mathematically as a standard linear program, see, for example “Algorithms for the Assignment and Transportation Problems,” James Munkres, Journal of the Society for Industrial and Applied Mathematics Vol. 5, No. 5 (March, 5957), pp. 32-38.

Linear programming has been shown to be an extremely powerful, essential optimization technique widely applied in various fields of study such as business studies and economics, as well as industrial areas such as engineering, transportation and manufacturing. The sophisticated mathematical programming techniques used in linear programming have proven essential to the modeling of diverse types of problems in routing, scheduling and assignment, and in turn have led to the creation of powerful computer systems that enable businesses to reduce costs, improve profitability, use resources effectively, reduce risks and provide untold benefits in many other key dimensions. Mathematically, linear programming is a technique for the optimization of a linear objective function, subject to linear equality and linear inequality constraints. While this requirement may seem overly restrictive, many real-world business problems can be formulated in this manner. Today, commercial linear-programming codes are able to solve linear programs with millions of constraints. For example, the commercial, high-performance mathematical programming solver IBM ILOG CPLEX of IBM is able to solve linear programs with the number of megabytes required for computation approximately equal to the number of constraints divided by 5000, see http://www-01.ibm.com/support/docview.wss?uid=swg21399933.

When dealing with large-scale systems, system components, such as the ordering backend 520, may employ techniques and results from Queuing Theory—the mathematical study of waiting lines, or queues—in order to model incoming customers or orders and subsequently make business decisions relating to order fulfillment, resource requirements for providing a certain service, expected waiting time in a queue, average time in a queue, expected queue length, expected number of customers in a queue at a given time, and the probability of a system to be in a certain state, such as empty or full. For example, it has been shown that most queues in restaurant operations can be described by an M/M/1 queue, where arrivals are determined by a Poisson process with heavy periods around lunch and dinner time, and service times have an exponential distribution. In a complex system of multiple M/M/1 queues, or a queue network, deep and sophisticated mathematical techniques such as stochastic calculus may be employed to model or approximate the queuing process. For example, in some implementations a heavy traffic approximation may be used to approximate a queuing process by a reflected Brownian motion, Ornstein-Uhlenbeck process or more general diffusion process. Since queues are basic components to both external and internal business processes, including scheduling and inventory management, understanding the nature of queues and learning how to manage them is one of the most important areas in operational research and management. See, for example, “A Methodology and Implementation for Analytic Modeling in Electronic Commerce Applications,” H. Edwards, M. Bauer, H. Lutfiyya, Y. Chan, M. Shields and P. Woo, Electronic Commerce Technologies, Lecture notes in computer science, Volume 2040, 2001, pp 548-157 and “Stochastic Models in Queuing Theory”, J. Medhi, Elsevier Academic Press, 2002.

The local fulfillment center workstations 530 may receive orders from the ordering backend 520. For example, a particular local fulfillment center workstation may receive an order for pizza from the ordering backend 520. The local fulfillment center workstations may be located on the premises of the local fulfillment center and used by agents of the local fulfillment center. For example, a local fulfillment center workstation of a pizza provider may be located in a kitchen of the pizza provider and used by bakers to determine what pizzas to bake and when to bake the pizzas. In another example, local fulfillment center workstations of a pizza provider may be located in delivery vehicles of the pizza provider and used by pizza deliverers to determine where to deliver each pizza or a delivery route for the pizzas. The delivery route may be dynamically planned based on types of orders and locations to which the orders will be delivered. In yet another example, a local fulfillment center workstation may be used by a cashier of a pizza provider and used by the cashier to place additional orders for customers within the restaurant or determine whether a customer is the correct customer to receive a pizza that is ordered for pickup at the restaurant.

The local fulfillment center workstations 530 may provide information to agents of the local fulfillment center to fulfill orders. For example, a particular local fulfillment center workstation of a pizza provider may display an order number, a type of pizza ordered, a customer name for the order, a place of delivery for the order, and a time of delivery for the order. The local fulfillment center workstations 530 may obtain the information to provide agents of the local fulfillment center from the orders received from the ordering backend 520. For example, the orders received from the ordering backend 520 may include data that indicates an order number, a type of pizza ordered, a customer name for the order, a place of delivery for the order, and a time of delivery for the order. In some implementations, the local fulfillment center workstations 530 may prioritize the fulfillment of orders. For example, the local fulfillment center workstations 530 may prioritize the fulfillment of orders based on when the orders are to be provided to the users.

The local fulfillment center workstations 530 may include a local, voice-based order taking component 532. For example, the local fulfillment center workstations 530 may include a telephone-based system with which an employee of the local fulfillment center may speak to the customer. The local, voice-based order taking component 532 may enable customers to place orders directly with the local fulfillment center. For example, the same local fulfillment center workstations 530 that receive orders from the ordering backend 520 may also be used to generate orders based on input from customer service agents using the local fulfillment center workstations 530. In some implementations, the local, voice-based order taking component 532 may be automated and use speech recognition to generate orders for users.

The local fulfillment center workstations 530 may additionally or alternatively communicate with a supply chain or finance or enterprise component of a third party. For example, a local fulfillment center workstation may place an order for more flour with a supply chain component of a third party that sells flour for pizza. In another example, a local fulfillment center workstation may communicate with a finance component to place payment charges for orders.

The local fulfillment center workstations 530 may automatically determine to communicate with the supply chain or finance or enterprise component. For example, the local fulfillment center workstations 530 may automatically determine that the amount of flour in the inventory of the local fulfillment center is below a flour threshold, and in response, place an order for flour to the supply chain component of a pizza flour provider.

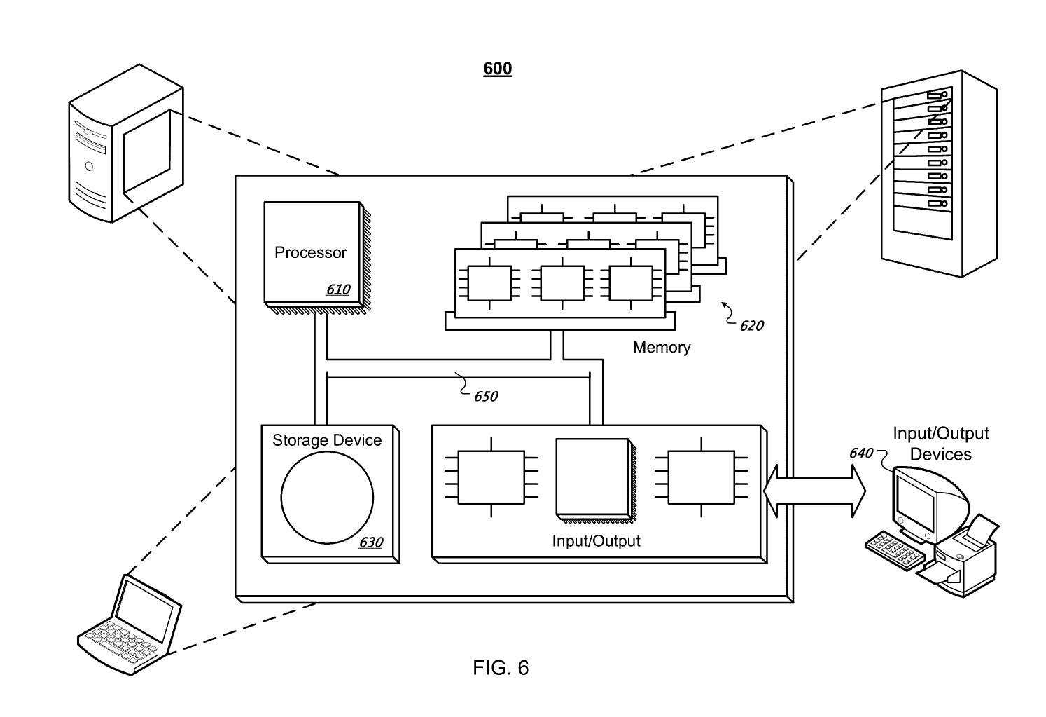

FIG. 6 illustrates a schematic diagram of an exemplary generic computer system. The system 600 can be used for the operations described in association with the processes 300 according to some implementations. The system 600 may be included in the system 500.

The system 600 includes a processor 610, a memory 620, a storage device 630, and an input/output device 640. Each of the components 610, 620, 630, and 620 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A computer-implemented method comprising:
receiving, at a computer system and from a mobile computing device, a food order that specifies one or more items to be (i) fulfilled by a particular provider and (ii) picked-up by a user of the mobile computing device;
determining, by the computer system, an estimated time of arrival for the user to travel from a current location of the mobile computing device to a location of the particular provider;
determining, by the computer system, one or more fulfillment time periods for the food order, each of the one or more fulfillment time periods corresponding to a length of time to fulfill a respective item that is included in the food order, wherein determining a fulfillment time period includes:
determining a base preparation time to prepare the respective item included in the food order; and
modifying the base preparation time based on one or more factors to determine the fulfillment time for the respective item, wherein the one or more factors include at least one of a historical order fulfillment time or a historical staffing level at the particular provider;
determining, by the computer system and based, at least in part, on (i) the estimated time of arrival and (ii) the one or more fulfillment time periods, one or more future times at which the particular provider is to begin preparing the one or more items so that the food order will be fulfilled and available for pick-up within a threshold period of time of the user arriving at the particular provider's location;
generating, by the computer system, food order instructions for the particular provider to prepare the food order based, at least in part, on (i) the food order and (ii) the one or more future times;
communicating, by the computer system, the food order instructions to a provider computer system associated with the particular provider to cause the provider computer system to display the food order instructions on a display device of the provider computer system;
receiving, at the computer system, an updated location of the mobile computing device;
determining, by the computer system, an updated time of arrival for the user at the location of the particular provider based, at least in part, on the updated location;
determining, by the computer system, whether the updated time of arrival for user to arrive at the particular provider's location has deviated from the estimated time of arrival by more than a threshold amount of time; and
providing, by the computer system and in response to determining that the updated time of arrival has deviated from the estimated time of arrival by more than the threshold amount of time, updated information that identifies the updated time of arrival for the user to the provider computer system associated with the particular provider.

2. The computer-implemented method of claim 1, further comprising:
selecting, by the computer system, an estimated route that the user will use to travel from the current location of mobile computing device to the location of the particular provider, wherein the estimated time of arrival is determined based, at least in part, on the estimated route.

3. The computer-implemented method of claim 2, further comprising:
identifying, by the computer system, one or more transit delays along the estimated route, wherein the estimated time of arrival is determined further based on the one or more transit delays.

4. The computer-implemented method of claim 2, further comprising:
identifying, by the computer system, historical travel times for travelling along some or all of the estimated route,
wherein the estimated time of arrival is determined further based on the historical travel times.

5. The computer-implemented method of claim 4, wherein the historical travel times comprise historical travel times for the user travelling along some or all of the estimated route.

6. The computer-implemented method of claim 2, further comprising:
identifying, by the computer system, a plurality of candidate routes for the user to travel from the current location of the mobile computing device to the location of the particular provider,
wherein the estimated route is selected from among the plurality of candidate routes based on historical travel patterns of the user.

7. (canceled)

8. (canceled)

9. The computer-implemented method of claim 1, further comprising:
determining, by the computer system, whether to suggest another provider fulfill the food order based, at least in part, on the updated location of the mobile computing device and the updated time of arrival at the location of the particular provider; and
selecting, by the computer system in response to determining to suggest another provider, an alternate provider for the food order based, at least in part, on (i) a location of the alternate provider, (ii) the updated location of the mobile computing device, and (iii) fulfillment services provided by the alternate provider or an affiliation between the alternate provider and the particular provider;
wherein the updated information includes information that identifies the alternate provider and provides an option to change fulfillment of the food order from the particular provider to the alternate provider.

10. The computer-implemented method of claim 9, further comprising:
receiving, at the computer system and from the mobile computing device, a request to change fulfillment of the food order to the alternate provider;
providing, by the computer system and to the provider computer system associated with the particular provider, instructions to cancel fulfillment of the food order by the particular provider; and
providing, by the computer system and to another provider computer system associated with the alternate provider, information for the food order.

11. The computer-implemented method of claim 1, further comprising:
determining, by the computer system and based on the updated time of arrival, one or more updated future times at which the particular provider is to begin preparing the one or more items so that the food order will be fulfilled and available for pick-up within a threshold period of time of the updated time of arrival; and
generating updated food order instructions for the particular provider to prepare the food order based, at least in part, on (i) the food order and (ii) the one or more updated future times, wherein the updated food order is included in the updated information that is provided to the provider computer system.

12. The computer-implemented method of claim 1, further comprising:
determining, by the computer system, whether fulfillment of the food order has already begun based, at least in part, on (i) a current time when the updated location of the mobile computing device is received and (ii) the one or more future times at which the particular provider is to begin preparing the food order;
providing, by the computer system and in response to determining that fulfillment of the food order has already begun, a notification to the mobile computing device that indicates the food order has already begun being fulfilled and an estimated time when the food order will be available.

13. The computer-implemented method of claim 1, further comprising:
determining, by the computer system, whether fulfillment of the food order has already begun based, at least in part, on (i) a current time when the updated location of the mobile computing device is received and (ii) the one or more future times at which the particular provider is to begin preparing the food order;
providing, by the computer system and in response to determining that fulfillment of the food order has not yet begun, instructions to the mobile computing device output one or more selectable features for the user to modify or cancel the food order.

14. The computer-implemented method of claim 13, further comprising:
receiving, at the computer system and from the mobile computing device, one or more modifications to the food order;
determining, by the computer system, one or more modified future times for the particular provider to being fulfilling the food order based, at least in part, on the one or more modifications to the food order and the future times; and
providing, by the computer system and to the provider computer system, information that identifies one or more modification to the food order and the one or more modified future times.

15. The computer-implemented method of claim 1, further comprising:
accessing, by the computer system, current orders that are pending for fulfillment with the particular provider, wherein the one or more future times are determined further based on the current orders.

16. A computer-implemented method comprising:
outputting, by the mobile computing device, a user interface for placing orders with one or more providers;
receiving, through the user interface, input that specifies a food order to be placed with a particular provider, wherein the food order includes one or more items and specifies that a user associated with the mobile computing device will pick-up the food order at the particular provider's location;
providing, by the mobile computing device and to a computer system, order information that describes the food order and location information that identifies a current location of the mobile computing device, wherein the computer system is programmed to (i) determine an estimated time when the food order will be available for pick-up based, at least in part, on an estimated time of arrival for the user to travel to the particular provider's location, the estimated time further based on one or more fulfillment time periods each indicating a length of time to fulfill a respective item included in the food order, and (ii) provide the food order to a provider computer system that is associated with the particular provider, wherein determining a fulfillment time period includes:
determining a base preparation time to prepare a respective item included in the food order; and
modifying the base preparation time based on one or more factors to determine the fulfillment time for the respective item, wherein the one or more factors include at least one of a historical order fulfillment time or a historical staffing level at the particular provider;
receiving, at the mobile computing device and from the computer system, information that identifies, at least, the estimated time when the food order will be available for pick-up;
outputting, by the mobile computing device and through the user interface, the estimated time when the food order will be available for pick-up;
providing, by the mobile computing device and to the computer system, location updates as the mobile computing device travels with the user to the particular provider's location;
receiving, by the mobile computing device and from the computer system, status information for pick-up of the food order, wherein the status information comprises information indicating that, as a result of a route being travelled by the user to the particular provider's location, the estimated time of arrival has deviated by at least a threshold amount of time;
selecting, by the mobile computing device and based on the information indicating that the estimated time of arrival has deviated by at least a threshold amount of time, one or more selectable user interface features for modifying or cancelling the food order
outputting, by the mobile computing device and through the user interface, the one or more selectable user interface features.

17. (canceled)

18. (canceled)

19. The computer-implemented method of claim 16, further comprising:
receiving, through at least a portion of the user interface features, input instructing the food order to be modified or cancelled;
providing, by the mobile computing device and to the computer system, instructions to modify or cancel the food order based on the user input.

20. A computer system comprising:
at least one processor; and
a memory communicatively coupled to the at least one processor, the memory storing instructions which, when executed, cause the at least one processor to implement modules comprising:
an interface that is programmed to (i) receive, from mobile computing devices, food orders that specify one or more items to be fulfilled by particular providers and picked-up by users of the mobile computing devices, (ii) provide food order instructions to provider computer systems associated with the particular providers;
a location module that is programmed to (i) determine current locations of the mobile computing devices and (ii) identify locations of the particular providers;
an arrival estimation module that is programmed to determine estimated times of arrival for the users to travel from the current locations of the mobile computing devices to the locations of the particular providers; and
a fulfillment planning subsystem that is programmed to (i) determine, for the food orders, fulfillment time periods that correspond to lengths of time for the items to be fulfilled as part of the food orders, (ii) determine future times at which the particular providers are to begin preparing the items so that the food orders will be fulfilled and available for pick-up within a threshold period of time of the users arriving at the particular providers' locations, and (iii) generate food order instructions for the particular providers based, at least in part, on the food orders and the future times,
wherein determining a fulfillment time period includes:
determining a base preparation time to prepare the respective item included in the food order; and
modifying the base preparation time based on one or more factors to determine the fulfillment time for the respective item, wherein the one or more factors include at least one of a historical order fulfillment time or a historical staffing level at the particular provider;
wherein the futures times are determined based, at least in part, on the estimated times of arrival and the fulfillment time periods,
wherein the interface is further programmed to receive updated locations of the mobile computing devices and to provide updated information that identifies updated times of arrival for the users to the provider computer systems associated with the particular providers,
wherein the arrival estimation module is further programmed to determine the updated times of arrival for the users based, at least in part, on the updated locations, and
wherein the fulfillment planning subsystem is further programmed to determine whether the updated times of arrival for users to have deviated from the estimated times of arrival by more than a threshold amount of time and to instruct the interface to transmit the updated information in response to determining that the updated times of arrival have deviated from the estimated times of arrival by more than the threshold amount of time.

21. The computer-implemented method of claim 16, wherein providing the location updates as the mobile computing device travels with the user to the particular provider's location comprises:
receiving, using a global positioning system (GPS) receiver that is part of the mobile computing device and at recurring intervals of time, wireless signals from a plurality of GPS satellites;
determining, using the GPS receiver, GPS coordinates for the mobile computing device based on the wireless signals received from the plurality of GPS satellites; and
transmitting, by the mobile computing device, the GPS coordinates to the computer system.

22. The computer-implemented method of claim 16, wherein:
outputting the estimated time when the food order will be available for pick-up comprises displaying, on a display of the mobile computing device, (i) first text that identifies the estimated time when the food order will be available for pick-up, (ii) second text that identifies one or more times when preparation of the one or more items in the food order will begin, and (iii) third text that identifies the particular provider,
outputting the one or more selectable user interface features through the user interface comprises displaying, on the display, one or more selectable buttons, and
the one or more selectable buttons are output at one or more positions on the display based on the dimensions of the display so that the one or more buttons, the first text, the second text, and the third text are displayed within distinct, non-overlapping areas of the display.

23. The computer-implemented method of claim 15, wherein identifying the one or more fulfillment time periods comprises:
identifying one or more base preparation times for the one or more items, the one or more base preparation times comprising one or more times to prepare the one or more items without any provider delay, the one or more base preparation times based at least in part on one or more historical order fulfillment times for the one or more items; and
determining, by the computer system, one or more delay times for each of the one or more items based on the current orders that are pending for fulfillment with the particular provider,
determining, by the computer system, the one or more fulfillment time periods by modifying the one or more base preparation times based on the one or more delay times.

24. The computer-implemented method of claim 1, further comprising:
determining, by the computer system, whether fulfillment of the food order has progressed at least less than a threshold amount based, at least in part, on (i) a current time when the updated location of the mobile computing device is received and (ii) the one or more future times at which the particular provider is to begin preparing the food order;
providing, by the computer system and in response to determining that fulfillment of the food order has not yet progressed at least the threshold amount, instructions to the mobile computing device output one or more selectable features for the user to modify or cancel the food order.
